(19) United States
(12) Patent Application Publication
(10) Pub. No.: US 2013/0167434 A1
(43) Pub. Date: Jul. 4, 2013

(54) Pole Saw Guide

(71) Applicant: GREGORY SCOTT FIRTH, Vista, CA (US)

(72) Inventor: GREGORY SCOTT FIRTH, Vista, CA (US)

(21) Appl. No.: 13/341,523

(22) Filed: Dec. 30, 2011

(51) Int. Cl. A01B 41/00

(52) U.S. Cl. 47/1.43

(57) ABSTRACT

A guide (23) supports a pole (22) by clamping a tree. (27) Guide (23) is a separate device which is comprised of a frame (24 25) which houses a tree clamp (31) and a pole clamp. (32) The use of guide (23) greatly extends the reach of a cutter. (21) Multiple poles (22) and guides (23) are added to reach a pre-determined cutting height. Guide (23) provides a stable elevated platform where a pivot point (71) is established. Leverage is thereby provided for positioning and moving cutter. (21) Trimming begins by activating cutter (21) and releasing pole clamp (32) allowing cutter (21) to engage with branches. (34) Additionally, branches (34) are also trimmed utilizing motor driven wheels (59) which provide rotation of guide, (23) pole (22) and cutter (21) around the perimeter of tree. (27)

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

A tree cutting apparatus comprising a remote cutting device which is manipulated at ground level by utilizing rigidly connected poles which are supported by guides that clamp both a tree and a pole.

### BACKGROUND ART

There are several groups of machinery that are related to the tree trimming device described in the following pages. These groups include: tree trimming equipment, pole saw arrangements, different support platforms utilized for tree trimming, and tree trimmers that utilize a pivot point in proximity to a cutting tool. The following patents represent a group of automated tree trimming robots that climb trees, trimming branches as they go: U.S. Pat. No. 2,228,635 to Mafinnis (1941), U.S. Pat. No. 2,482,392 to Whitaker (1949), U.S. Pat. No. 2,541,767 to Jones (1951), U.S. Pat. No. 3,451,448 to Michiner (1969), and U.S. Pat. No. 6,474,377 to Mortel. (2002) Robots of this type utilize complicated and expensive equipment, requiring skill to operate. Cutting tools are robotically yielded from a moving platform which climbs a tree. The climbing robots are constructed generally using a ring which is placed around the perimeter of a tree. The ring is fitted with motorized wheels which roll over the surface of a tree lifting the robot towards the top of the tree. Tree limbs are cut as the machine goes up a trunk. Robotic tree trimmers are not designed for use by the general public because of the weight and complexity of the machinery.

A simpler method is to use a human supported cutter. Human supported tree trimmers have been utilized extensively in the past. These tree trimmers are commonly known as pole saws. There are numerous examples of pole saws with various shaft designs such as: U.S. Pat. No. 4,654,971 to Fettes (1987), U.S. Pat. No. 4,760,646 to Seigler (1988), U.S. Pat. No. 4,991,298 to Caruso (1991), U.S. Pat. No. 5,013,282 to Keller (1991), U.S. Pat. No. 5,493,758 to Carmien (1996) U.S. Pat. No. 5,411,238 to Caron (1995), U.S. Pat. No. 5,926,961 to Uhl (1999), U.S. Pat. No. 6,474,747 to Beaulieu (2002), U.S. Pat. No. 6,488,511 to Stewart (2002), U.S. Pat. No. 7,484,300 to King (2009). These patents utilize a long hand held pole in various configurations with a chain saw mounted on the end. The saw is lifted in an overhead position toward a particular branch for trimming. Force is then exerted by an operator during a cutting process. The branch cuts through resulting in loss of resistance against the saw. The saw continues in motion at the end of the pole which can cause the operator to lose balance, especially while standing on a ladder. An additional drawback is that it is difficult to maneuver a chain saw mounted at the end of a long pole. The longer the pole, the greater the problem becomes. This fact is due to the absence of a support platform in proximity to the chain saw.

Other designs for tree trimming utilize platforms for supporting a human holding chain saw. An operator is able to climb a tree using a platform and then safely trim or cut a tree. An example of this type of support platform is U.S. Pat. No. 4,244,445 to Strode (1981). This is another example that a support platform in proximity to a cutting tool is an advantage.

A ground supported device having a pivot point in proximity to a cutter is seen in U.S. Pat. No. 7,093,366 to Black (2006). This configuration uses a ground supported pole with a guide for maintaining a constant height while trimming hedges. The intention of this device is hedges and not trees because of obvious height limitations. A similar design is seen in U.S. Pat. No. 5,001,858 to Frazar (1991), where multiple poles are used to create an elevated pivot point in proximity to a cutting tool. This is an improvement over the previous design because an elevated and stable pivot point is created. The problem with this design is the need to re-position multiple poles in different locations each time the pivot point is moved. Another problem is that an increasingly vertical angle of the pole saw is necessary as longer poles are used to elevate a pivot point.

To overcome these problems a different approach is revealed where a tree is used to support a pivot point in proximity to a cutter. In U.S. Pat. No. 6,901,695 to Lindroth (2005) and U.S. Pat. No. 5,787,536 to Pate, (1998) a hook is placed up in a tree using a long pole. The hook goes around a horizontal section of a limb providing a lifting point. A pole saw is then hoisted up the tree using rope until positioned underneath the hook. The pole is then able maneuver the saw hanging from the rope. If the limb is higher than one can hook, then it cannot be cut or trimmed. This design is limited to cutting in proximity to a relatively horizontal section of limb. Using a hook to hoist up a saw is difficult on a vertical section of tree.

A chain saw holder with a guide is shown in U.S. Pat. No. 2,974,694 to Mattila. (1961) This configuration does not utilize poles. In U.S. Pat. No. 7,913,403 to Willetts, (2011) a tree clamping mechanism is shown in proximity to a cutter. In this example, a tree clamping device holds a portion of a limb which is to be cut. The clamp is an optional device which secures debris that could fall. The optional clamp is also intended to engage a reciprocating cutter with a limb. The clamp is attached directly to the housing of the saw so that the vibration generated during cutting is efficiently transferred to a limb. A tree clamping device is clearly advantageous. A pole is also advantageous for controlling a saw. A combination of these two elements and more provide the basis for a new method and apparatus that greatly improves tree trimming.

### SUMMARY OF INVENTION

A tree cutting device that utilizes one or more poles to transfer motion generated at ground level to the top of a tree. A swing arm transfers the motion to a cutter from the top of the pole. Located below the swing arm are one or more guides that are made up of a tree gripping clamp and a pole gripping clamp. Guides support poles. Two different cutting processes are possible using pole guides. First attach the swing arm to the pole. Then attach the guide to the pole just below the swing arm. Lift the pole bringing the cutter in proximity of branches to be cut. Grip the tree with the tree clamp and it is ready to begin trimming. The first way is to activate the cutter, loosen the pole clamp and then slide, rotate, and pivot the pole. A pivot point in proximity to the cutter is supported by the tree. Tightening the pole clamp causes the pole to lock in perpendicular to the guide supporting the entire device. The second way to trim is to first grip tight with the pole clamp. Lock in pole with cutter aligned to intersect branches. Activate the cutter and loosen the tree clamp. Branches are cut as the operator walks around the perimeter of the tree supporting the pole. Once again the pivot point is in proximity to the cutter. The guide holds the cutter at a constant distance away from the surface of the tree during rotation resulting in perfectly circular cuts.

### Object and Advantages

a. To provide a tree trimming tool that can be used by the general public.
b. To provide a way to trim trees that is extremely quick and easy.
c. To provide tree trimming that is affordable.
d. To provide a way to trim trees that is ground based.
e. To provide a way to cut a pineapple shape at the top of a tall palm tree.
f. To provide a way to harvest fruits from the tops of trees such as coconuts or dates.

### DESCRIPTION OF THE DRAWINGS

FIG. 1 Side view of tree with three guides, three poles, a swing arm and a control arm.

FIG. 2 Side view of a single guide and a hand saw.

FIG. 3 Side view of a multiple guide and a chain saw.

FIG. 4 Plan view of a guide with a tree clamp and a pole clamp in open position.

FIG. 5 Plan view of a guide with a tree clamp and a pole clamp in loose position.

FIG. 6 Plan view of a guide with a tree clamp and a pole clamp in tight position.

FIG. 7 Plan view of a single guide with a pole clamp in open position.

FIG. 8 Plan view of a single guide with a pole clamp in tight position.

FIG. 9 Plan view of a preferred pole clamp in open position.

FIG. 10 Plan view of a preferred pole clamp in loose position.

FIG. 11 Plan view of a preferred pole clamp in tight position.

FIG. 12 Perspective view of a preferred guide in open position.

FIG. 13 Perspective view of a preferred guide in loose position.

FIG. 14 Perspective view of a preferred guide in tight position.

FIG. 15 Perspective view of a rod end for clamping a pole. FIG. 16 Perspective view of a preferred pole clamp.

Reference Numerals:

| | | |
|---|---|---|
| 20. swing arm assembly | 21. cutter | 22. poles |
| 23. multiple guide assembly | 24. vertical frame | 25. horizontal frame |
| 26. single guide assembly | 27. tree | 28. control arm |
| 29. support arm | 30. arm collar | 31. tree clamp |
| 32. pole clamp | 33. hand saw | 34. branches |
| 36. tool holder | 37. hand grips | 38. clamp body |
| 39. carriage (cyl.) | 40. pole collar | 41. hinge |
| 42. wheel | 43. pole rod end | 44. pole hook |
| 45. belt | 46. belt lock | 47. lever |
| 48. linear actuator | 51. threaded rod | 53. grip axis |
| 54. grip arm | 55. spherical | 56. block |
| 57. U-bolts | 58. mounting plate | 59. drive wheel |
| 60. pole linear actuator | 61. pole channel | 62. roller cam |
| 63. drive motor | 65. rod end connector | 67. cam plate |
| 68. pole lock arm | 69. carriage (screw) | 70. shaft |
| 71. pivot point | 72. ratchet handle | 73. ratchet handle |

### DETAILED DESCRIPTION

### FIG. 1

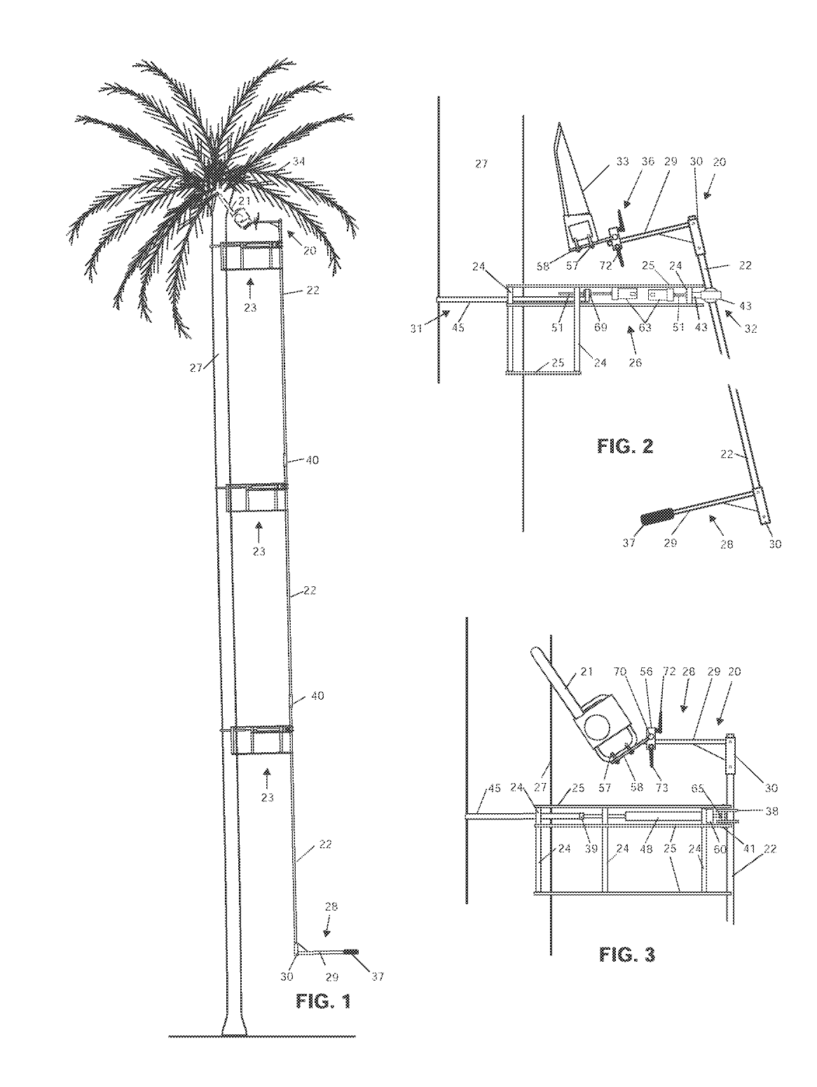

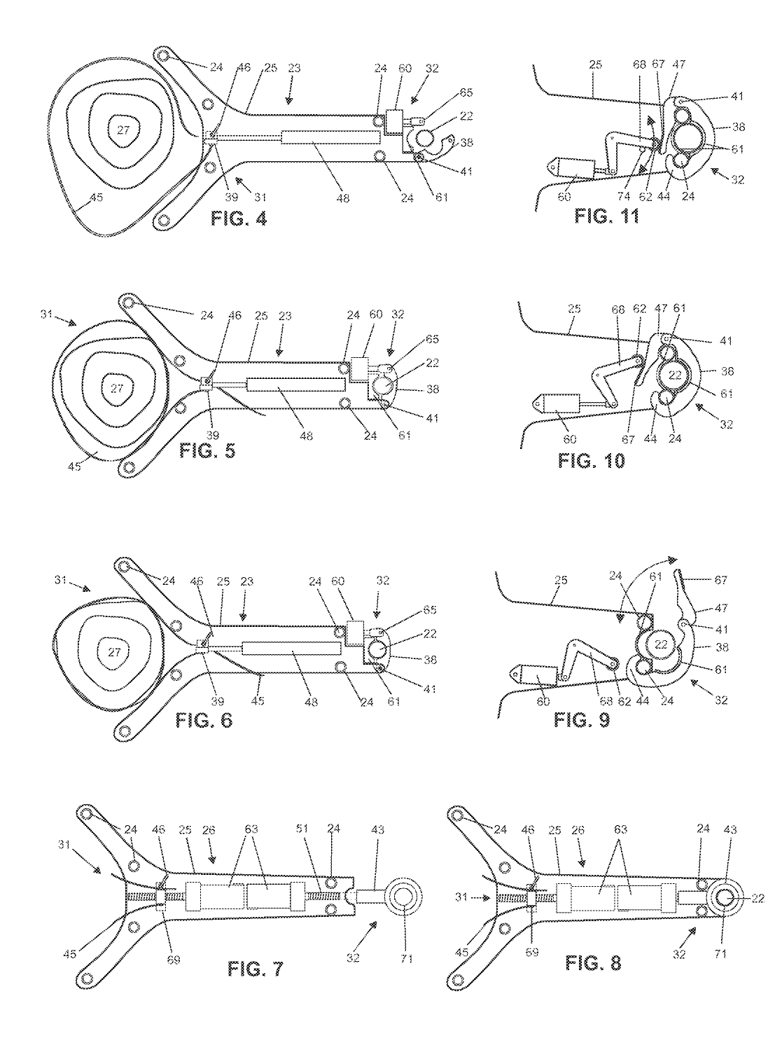

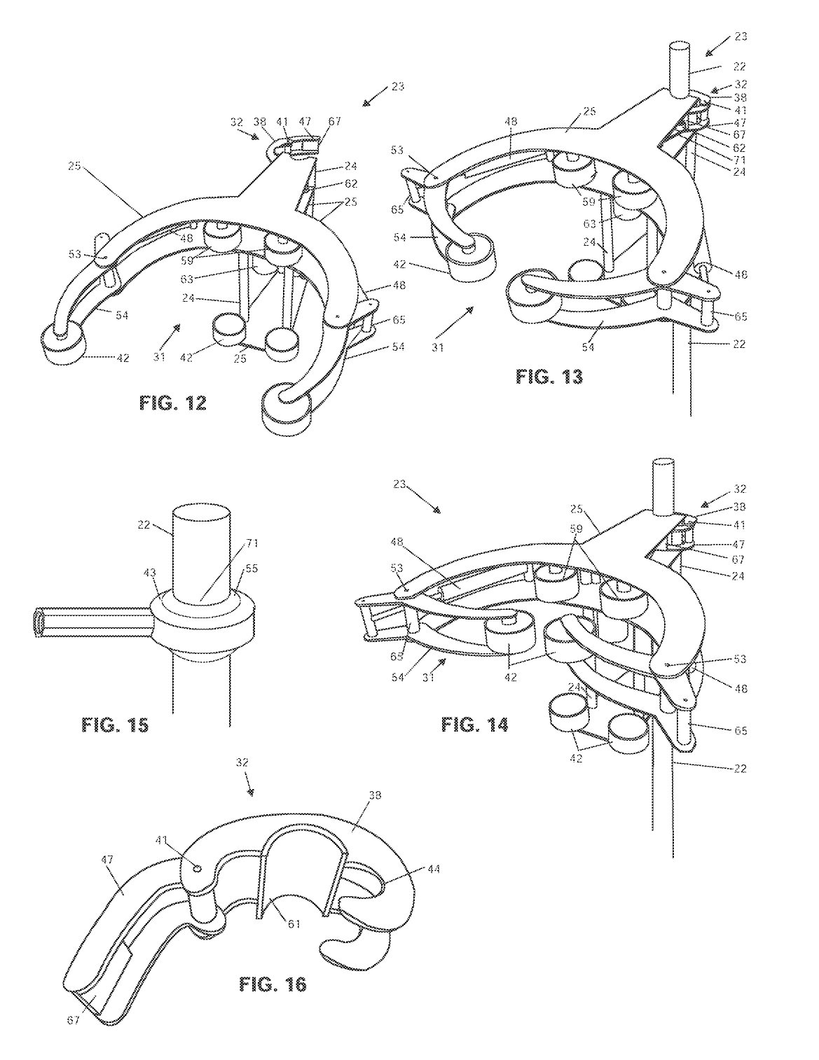

Necessary parts for a tree trimming setup include: a suitable tree, 27 a cutting device, 21 one or more guides, 23 26 one or more poles, 22 a swing arm, 20 and an operator. (not shown) A control arm 28 is shown but is not necessary for a trimming operation. A tree 27 is important to consider because it is used to support one or more guides. 23 26 Several guides 23 and several poles 22 are proposed for use in a trimming operation, however using a single guide 26 is of great advantage. The components of guide 23 26 are held in place by a frame. 24 25 Many different frame configurations can house components. A simple frame design is shown for illustration using a vertical support frame member 24 and a horizontal support frame member. 25 The structure of frame 24 25 is also seen in perspective views. FIGS. 12-14. A closer look at the components of a guide and how they fit into frame 24 25 continues. FIGS. 2 and 3

Guide 23 26 consists of two clamping mechanisms that are mounted at opposite ends in frame. 24 25 One clamp 31 grips tree 27 and the other clamp 32 grips pole. 22 Pole clamp 32 as shown in FIG. 2 has a pivotal rod end fitting 43 that allows pole 22 to swivel and slide when loosened. A pivot point 71 is created by guide 26 whereby leverage can be applied to a hand saw. 33 This setup is used in single guide 26 applications. Multiple guide 23 applications utilize a different pole clamp 32 as seen in FIG. 3. Multiple guide 23 frame 24 25 is extended lower on pole 22 which increases stability. Added stability is necessary in lifting multiple guide 23 up tree. 27 Tree clamp 31 utilizes a belt 45 which goes around the circumference of tree 27 as shown in FIGS. 1-8. Belt 45 is tension able which results in tree 27 being gripped by guide. 23 26 Belt 45 is loosen able which allows guide 23 26 to travel vertically along tree. 27 Belt 45 is open able allowing guide 23 26 to be removed. Many linear motion devices suffice for powering tree clamp 31 and pole clamp 32 however, the simplest systems are preferred. Motor 63 drives the clamping force as seen in FIG. 2 and linear actuator 48 60 drives the clamping force in FIGS. 1, 3 - 14. A guide by itself will not accomplish the desired task of tree trimming. For that purpose a cutter 21 is used.

Cutter 21 represents any portable hand held tree trimming tool such as a chain saw. A versatile tool holder 36 is provided for mounting cutter 21 in a variety of ways. Tool holder 36 is comprised of a mounting plate 58 with holes drilled in multiple locations for fitting a variety of U-shaped bolts. 57 U-shaped bolts 57 and mounting plates 58 are provided in various widths and lengths for mounting many different cutters. 21 Mounting plate 58 is affixed to a shaft 70 which is housed in a block 56 and clamped by a ratchet handle. 73 Block 56 also houses a portion of a support arm 29 which is clamped by a second ratchet handle. 72 Block 56 and ratchet handles 72 73 provide a multiple axis adjustment for aligning cutter. 21 Tightening ratchet handles 72 73 will secure cutter 21 rigidly to support arm. 29 Support arm 29 attaches further to pole 22 with an arm collar. 30 Collar 30 is affixed to arm 29 at a perpendicular angle. The entire assembly including cutter 21 is a swing arm assembly. 20 Swing arm 20 attaches to the top of pole. 22

Multiple poles 22 are rigidly connected end to end with a pole end collar 40 to reach great heights; in large steps, very quickly. Multiple guides 23 are added to provide support for multiple poles. 22 When a desired trimming height is reached then control arm 28 is attached at the base. Control arm 28 transfers human generated motion to pole 22 through one or more hand grips 37 that are attached to support arm. 29 The human generated motion on ground level is mimicked by cutter 21 at the top of tree. 27 Control arm 28 is made up of hand grips 37 connected to support arm 29 which is affixed to arm collar 30 at a perpendicular angle. Assembling and using the parts previously described will produce a device capable of trimming trees of great height.

There are other parts which are beneficial, but are not essential for operation. Some of these parts include: remote video viewing, radio control of functions, shielding for falling debris, different types of cutters, different pole interlocking systems, different clamping systems, different power sources and different tool mounting configurations as typically shown by prior art. Another beneficial part would be to add a wheel to the base of pole 22 for added support. Discussion over necessary parts continues with more detail on how guide 23 26 works. FIGS. 4-11

Guide 23 26 is an assembly made up of tree clamp 31 and pole clamp 32 housed in frame. 24 25 Clamps 31 32 are remote controlled and have a gripping tight position, a holding loosely position, and an open position. FIGS. 4, 7, and 9 illustrate clamps 31 32 in the open position. The open position is used during a setup or breakdown procedure however; bypassing limbs on a tree trunk is also achieved with a remote controlled open position. FIGS. 5 and 10 show clamps 31 32 in the holding loosely position. The holding loosely position for tree clamp 31 allows it to travel vertically along tree. 27 The holding loosely position for pole clamp 32 allows pole 22 to slide, rotate, or swivel. FIGS. 6, 8 and 11 show clamps 31 32 that are gripping tightly. The gripping tight position for tree clamp 31 causes guide 23 to align itself perpendicular to tree. 27 The tightening of pole clamp 32 causes pole 22 to align perpendicular to guide. 23 When both clamps 31 32 are tightened, pole 22 will align itself parallel to tree 27 and support the entire weight of the assembly.

There are many mechanical solutions for accomplishing clamping action. A simple way to grip tree 27 is to put one or more belts 45 around the circumference. Belt 45 is attached to linear actuator 48 by using a carriage. 39 The other end of belt 45 fits into a lock 46 that holds belt 45 at any length. Another simple way to grip pole 22 is by using a hinged 41 clamp body. 38 Linear actuator 60 exerts force through a rod end connector 65 which is pinned to clamp body. 38 The open position is achieved by hand removing a pin. (not shown) A pole receiving channel 61 is oriented to accept pole 22 and to receive forces caused through clamping.

Another way to accomplish clamping is by using a rod end connector 43 that fits pole. 22 FIG. 15 Connector 43 has a spherical portion 55 allowing free movement around an axis which provides a pivot point. 71 Pole clamp 32 in loose position allows pole 22 to slide, rotate and swivel. Pole clamp 32 in tight position locks pole 22 to guide 23 at a perpendicular angle. FIG. 2 The linear motion for clamping is powered by drive motor. 63 The rotational shaft of motor 63 is attached to a threaded rod. 51 A carriage 69 receives rod 51 whereby rotation of rod 51 results in linear motion of carriage 69 tightening tree clamp. 31 Pole clamp 32 also acquires linear motion through rotation of rod 51 which aligns pole 22 parallel to tree. 27 Pole rod end 43 pulls pole 22 into pole channel 61 by rotation of rod. 51

### PREFERRED EMBODIMENT

FIG. 16

A preferred pole clamp 32 is comprised of pole channel 61 which is affixed perpendicular in clamp body. 38 Clamp body 38 is formed with a hook 44 for fitting around a part of vertical support frame. 24 The other side of clamp body 38 has a hinge 41 which connects to a lever. 47 FIGS. 9-11 Fitting hook 44 around frame 24 and then using lever 67 to close around a secondary frame member 24 causes pole 22 to be clamped. Linear actuator 60 acts on a pole locking arm 68 which connects to a cam roller. 62 Cam 62 rolls on a cam plate 67 which is affixed to lever. 67 As cam 62 rolls along plate, 67 the clamping force increases to a point. As cam 62 continues further along plate, 67 lever 47 is released providing open position. As cam 62 travels to the other side of plate, 67 loose position is assumed by pole clamp. 32 A hand removable pin 74 is inserted which stops the travel of cam. 62 Pole 22 is firmly gripped in this position. Pin 74 also prevents lever 47 from releasing during a trimming session. Action by linear actuator 60 provides loose and grip positions. The preferred pole clamp 32 is also seen in FIGS. 12-14 in all three positions. A preferred tree clamp 31 is also seen. Wheels 42 are provided to allow guide 23 to roll around the perimeter of tree 27 while gripping. Drive motor 63 provides motorized rotation of at least two drive wheels. 59 Drive transmission is not shown. 14 A lower frame assembly supports a second set of wheels 42 which are supported by a lower portion of frame. 24 25 Frame 25 continues toward pole 22 and terminates with pole channel. 61 The preferred tree gripping clamp 31 uses multiple grip arms 54 that rotate around an axis. 53 Linear actuator 48 connects to a rod end connector 65 which in turn connects to grip arm. 54 Action by linear actuators 48 cause grip arms 54 to close or open around the perimeter of tree. 27 Grip arms 54 are seen in open, loose, and closed positions. FIG. 12—The structural design described provides a rotatable platform providing a pivot point in proximity to cutter. 21

Operation:

There are many ways to use the hardware provided. A use in this case is to trim a palm tree as shown in FIG. 1. Begin by attaching cutter 21 to tool holder. 36 Attach swing arm 20 to pole. 22 Attach guide 23 with motorized rotation 62 59 to pole. 22 Lift pole, 22 and use tree clamp 31 to grip tree 27 which allows an operator to prepare a second pole 22 and guide 23 for use. Only the top guide 23 needs motorized rotation 63 59 because that is where resistance from cutting occurs. Attach a second pole 22 with guide 23 using pole collar. 40 Release tree clamp 31 and lift second pole 22 allowing space for a third pole. 22 Likewise third pole 22 and guide 23 are added bringing cutter 21 to the desired height in tree. 27 Next, grip tree 27 so that the weight of the entire setup is supported rendering the operator hands free to attach control arm. 28 Attach control arm. 28 Activate cutter, 21 loosen pole clamps 32 and start trimming. The operator is holding the weight of cutter, 21 swing arm, 20 poles 22 and control arm. 28 As the operator maneuvers control arm 28 at ground level, cutter 21 follows exactly at the top of tree 27 trimming branches. 34 Branches 34 are trimmed in the same manner as if the operator were standing beside tree 27 holding cutter. 21 After trimming is completed in that section of tree, 27 grip pole 22 and loosen tree clamps 31 for rotation. The operator decides next to trim branches 34 while using motorized rotation. 59 63 Initiating rotation during trimming has height limitations when using a pole alone. Cutter 21 encounters branches 34 during rotation and resistance increases. As branches 34 are cut, a sudden loss of resistance occurs. Cutter 21 jumps forward to the next branch 34 resulting in a diminished quality cut. To solve this problem and improve quality, drive motor 62 and wheels 42 59 are provided to engage cutter 21 at an even rate of speed. To continue with motorized rotation; position and lock in cutter 21 so that branches 34 are intercepted during rotation. Activate cutter 21 and drive wheels 59 to begin trimming. Walk around base of tree 27 holding control arm 28 at a constant height from the ground. Complete a full circle around tree 27 and set a new position for cutter. 21 Complete several circles around tree 27 with cutter 21 set at different positions to form a variety of different shapes. To reset cutter 21 position loosen pole clamps and re-position cutter. 21 Grip pole 22 to lock in position. Using this easy method, a pineapple shape is quickly formed at the top of tree. 27 Rotation during trimming at lesser height is accomplished using belt 45 type tree clamp. 31 First grip pole 22 and loosen tree clamp 31 with cutter 21 positioned to intercept branches. 34 Circle tree 27 as previously described trimming branches.

### CONCLUSION

A homeowner can save substantial money with the ability to trim their own trees. The only alternative is to hire professionals who climb up a tree or use a lift to reach high branches. Many people have tragically lost their lives by climbing to the top of a tree carrying a chain saw. Trimming in this manner commonly requires a trimmer to cut branches by lifting a chain saw overhead. The use of this tool enables the homeowner, farmer, landscaper or gardener to produce beautifully trimmed trees without ever leaving the ground.

I claim:

1. An apparatus for trimming and removing trees with a cutter comprising:
a swing arm and a guide that attach to a pole wherein;
swing arm comprising:
a mounting means of said cutter to a tool holding means, and said tool holder affixed to a support arm, and
support arm further affixed to a pole attachment collar whereby swing arm assembly is held rigidly perpendicular to said pole;
guide comprising:
a frame housing a tree clamp and a pole clamp,
said tree and pole clamps having gripping means providing an open, loose, and gripping tight position,
whereby a pivot point in proximity to said cutter is supported.

2. An apparatus for trimming and removing trees with a cutter comprising:
(a) swing arm comprising a support arm with attachments at each end with the first being a tool holder for mounting said cutter, and the second being a pole attachment collar for attaching said swing arm to a pole,
(b) pole comprising a tubular member that connects end to end with a slip joint connection providing a bridge between said pole ends providing a ridged connection,
(c) guide comprising a frame housing two clamping devices, one being a pole clamping means and the other being a tree clamping means,
(d) control arm comprising a support arm with affixed attachments, with the first being said pole collar and the second attachment is one or more hand grips whereby human generated motion at ground level is transferred to said cutter at the top of said tree.

3. An apparatus according to claim 2 wherein a gripping means is provided by said tree clamp comprising one or more grip arms that pivotally rotate around an axis thereby providing an open, loose and gripping tight position.

4. An apparatus according to claim 2 wherein an alternative gripping means is provided by said tree clamp comprising a belt looped around said tree and attached to the carriage of a linear actuator thereby providing an open, loose and gripping tight position.

5. An apparatus according to claim 2 with said tree clamp containing a rotational drive means comprising multiple wheels with one or more of said wheels being motor driven.

6. An apparatus according to claim 2 wherein linear motion for clamping is provided by a carriage that receives a motor driven threaded rod.

7. An apparatus according to claim 6 with said pole clamp comprising a pivot able rod end connector with a receiving connection to said threaded rod thereby providing an open, loose and gripping tight position.

8. An apparatus according to claim 2 with an alternative pole clamping means comprising a hinged clamp body in attachment to a linear actuator thereby providing an open, loose and gripping tight position.

9. Two methods for trimming trees using a pole saw guide first being:
a. providing a pole saw and attaching said guide gripping tight to a section of said pole, and
b. lifting said guide towards the top of a tree, and
c. gripping a vertical section of said tree, and
d. releasing said pole clamp holding loosely said pole, and then
e. cutting with said cutter whereby said tree is trimmed; and the second method being:
a. providing said pole saw attaching said guide gripping tight to a section of said pole, and
b. lifting said guide towards the top of said tree, and
c. holding loosely a vertical section of said tree, and
d. cutting with said cutter by rotating around the perimeter of said tree whereby trimming occurs.
